(19) United States
(12) Patent Application Publication
(10) Pub. No.: US 2006/0207430 A1
(43) Pub. Date: Sep. 21, 2006

(54) Method and apparatus for automatically removing radon gas in a sump well

(76) Inventors: Xianli Huang, Northville, MI (US); Xiaowei Li, Northville, MI (US)

Correspondence Address: XIANLI HUANG, 17006 ABBY CIRCLE, NORTHVILLE, MI, 48167, US

(21) Appl. No.: 11/081,102

(22) Filed: Mar. 16, 2005

(51) Int. Cl. B01D 19/00

(52) U.S. Cl. 96/193

(57) ABSTRACT

This invention relates to an apparatus and a method for automatically removing radon gas trapped in a sump pit in a residential dwelling basement and dispensing it harmlessly into the atmosphere. This apparatus uses a Venturi nozzle in the discharge pipe from an existing sump pump system, sucks the radon gas in the sump pit when the sump pump pumps water and discharges it to atmosphere together with the discharged water through the existing discharge pipe of the sump pump system. The invention also relates to a radon inlet which floats with water surface to maximize the drawing of the radon gas. Two embodiments are present: One is suitable for underground water rich area and other is suitable for radon gas rich area to which a water storage and replenish tank is added.

### BACKGROUND OF THE INVENTION

The present invention relates to vent devices which use a sump pump in an existing sump pump system as a pumping power to draw the noxious radon gas trapped in a sump pit in a residential dwelling by using a Venturi Nozzle and disperse the radon gas via the existing discharge pipe in the sump pump system to the outside atmosphere.

### DESCRIPTION OF THE PRIOR ART

Radon is a radioactive gas. It comes from the natural decay of uranium which can be found in nearly all soils. It is odorless, tasteless and poses a significant health hazard to people. It is well documented by Environment Protection Agency (EPA) that Radon causes up to 21,000 deaths each year in the United State. Residence living in a dwelling may expose to the hazard gas. The major radon gas sources in a residential dwelling, according to EPA's A Citizen's Guide to Radon, are from soil and underground water. A sump pit in a residential dwelling is hence the major point of entry of radon gas. Removing radon gas from a sump pit could mitigate radon level in a residence significantly.

There are a variety of devices in prior arts which employ the use of electrical fans and venting systems to draw the radon gas from a sump pit and discharge it into the atmosphere. Such devices basically include a motor, a fan, and venting pipes to draw the radon gas from the sump pit and discharge it.

There are many patent references which disclose methods and devices for reducing the level of radon gas in a dwelling. U.S. Pat. No. 6,524,182 B2, which issued on Feb. 25, 2003 to Kilburn, relates to a kit for mitigating radon gas in a dwelling by a system comprising of a suction pipe, an exhaust vent hood and an axial fan. U.S. Pat. No. 4,957,394, issued Sep. 18, 1990 to Jarnagin etc., invented an apparatus and method for collecting and removing noxious gases by a system which includes a fan, a collection chamber. U.S. Pat. No. 4,798,034, issued Jan. 17, 1989 to Jarnagin, etc., presents a method and apparatus to create a sealed system around the inside perimeter, including a sump well, in a residential house, collect the radon gas and fluids and discharge the collected fluids and radon gas into exterior of the house by an electrical motor-fan-venting system. U.S. Pat. No. 5,836,815, issued Nov. 17, 1998 to Jennemann, relates to a radon in-ground collection basin with liners, plenum chamber and conduit system. Trapped radon gas can be drawn by a motor-fan system.

The disadvantages of these methods and devices are: the systems are complex to build, install and maintain; the systems require an additional motor and additional ventilation piping system to draw the radon gas from the sump pit and discharge it into the atmosphere.

### SUMMARY OF THE INVENTION

Accordingly, it is an object of the present invention to provide a novel method and apparatus for removing the radon gases from the sump pit to avoid the disadvantages of the prior art, which is simple in manufacturing, easy on installation, maintenance, cost effective and high efficient.

It is another object of the present invention to eliminate the additional motor and vent piping system. Said apparatus makes use of the existing sump pump to draw the radon gas collected in a sump pit by a venture nozzle in the existing discharging pipe system and discharge the radon gas into the atmosphere with the water by the existing discharging pipe system for the sump pump system.

It is yet another object of the present invention to provide a radon inlet device which floats with water and draw the radon on water surface more efficiently.

### BRIEF DESCRIPTION OF THE DRAWING

FIG. 1 is one embodiment for the radon removing apparatus by using a venturi nozzle which is most suitable in an area which has rich underground water and less radon gas in a residential dwelling basement.

FIG. 2 is the other embodiment for the radon removing apparatus for general purpose of removing radon gas and more specifically suitable for an area in which has less underground water and more radon gas in a sump pit in a residential dwelling basement.

FIG. 3 shows the flow chart for the control of the sump pump.

FIG. 4 illustrates the unit of the radon gas inlet. This inlet floats with water surface as water level increases or decreases.

### DETAILED DESCRIPTION

As EPA's <Consumer's Guide to Radon Reduction> pamphlet described that radon is a naturally occurring radioactive gas. It enters houses from the soil in a residential house's foundation and underground water. The sump pit is one of the radon gas collection areas in a house. Radon gas is heavier than air so when it is released from underground soil into a pump pit it will not escape to outside by itself and but is settled and trapped on the water surface of the sump pit instead. It has to be drawn and discharged to the outside of the home and harmlessly dispersed in the atmosphere.

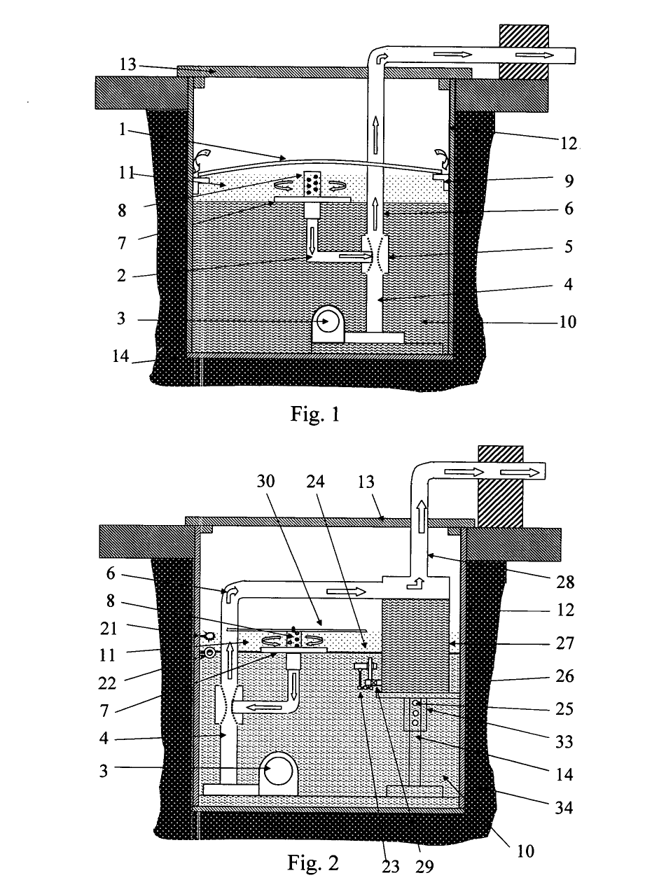

FIG. 1 illustrates the radon gas removing system. A cover 13 and sump wall 12 form a sump pit. The pump 3 and discharge pipe 4 and 6 are a typical sump pump system commonly used in a sump pit in a dwelling basement. Two ends of a venturi nozzle 5 are connected to said discharge pipes 4 and 6 respectively. The inlet pipe 2 of said venture nozzle 5 is connected the radon inlet 8. Said radon inlet's top end is closed and its body is perforated with holes. Radon gas 11 released from underground soil 14 and underground water 10 in a dwelling basement and is settled on water surface since it's heavier than air. When the water collected in said sump pit rises to a predetermined level the sump pump is activated automatically to pump water and discharge it through the discharge pipe 4, said venturi nozzle 5 and discharge pipe 6. When the pumped water goes through said venture it sucks the air in said inlet pipe 2 and hence sucks the radon gas above the water surface into the inlet pipe 2 through said radon inlet 8's perforated holes. The sucked radon gas is mixed with discharged water in said venturi nozzle 5 and discharged outside with the water through discharge pipe 6. The float 7 is made of light material and is mounted to said radon inlet 8. Said float 7 keeps said radon inlet 8 just floating on the water surface. When water level decreases during the sump pump discharging process, the float 7 will move with water surface downwardly together with said radon inlet 8. When water level increases during the period of the pump rest, the float 7 will move with water surface upwardly together with said radon inlet 8. The reason is that the radon is heavy gas, when the pump is discharging the water, the water level will decrease hence the radon gas will move downwardly with water surface. The radon inlet 8 moving synthetically with water surface guarantees the efficiency of drawing the radon into said inlet pipe 8. The retention cover 1 is used to block the air directly to occupy the vacancy left by the sucked radon gas around said radon inlet 8, instead, the air sucked is guided by said cover from its edge perimeter into the space between said cover 1 and water surface and pushes the radon gas in the space further to the adjacent area of the radon inlet 8 so that the radon gas will be sucked efficiently into said radon inlet 8.

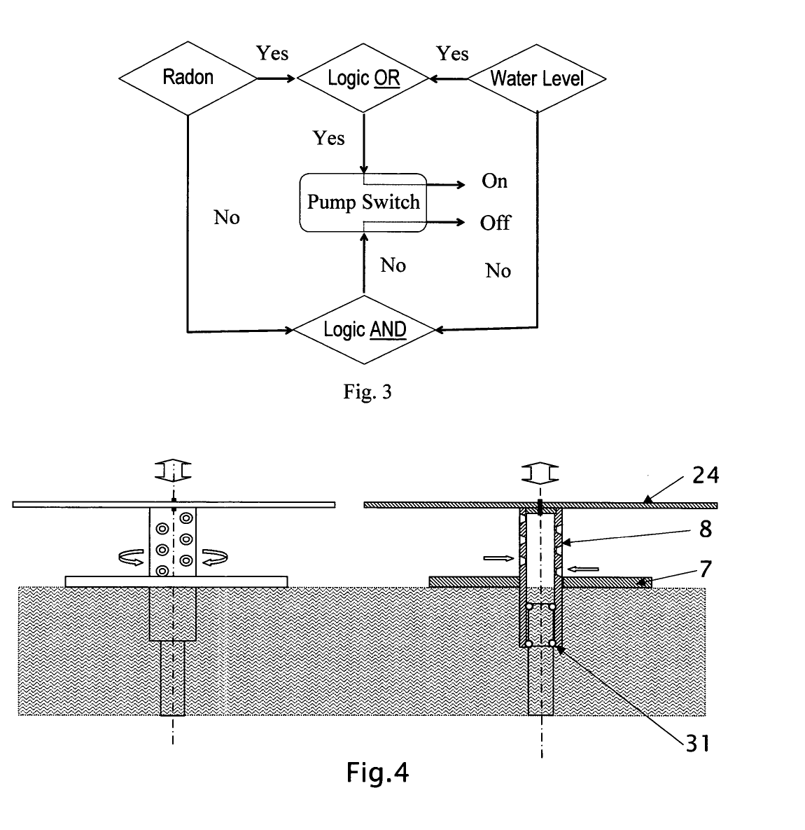

FIG. 2 shows another embodiment of the radon removing system. A radon sensor 21 and a water level sensor 22 (For example: a Float Switch) are mounted on the wall of the sump bit. The sump pump 3 is activated automatically by either of the conditions below: when the radon sensor senses the radon gas trapped above the water surface or the water collected in said sump pit reaches to a predetermined level. Once one of the conditions is met said sensors send a signal to a switch to turn the sump pump on to pump water and thereby draw the radon through said venture 5 and radon inlet 8 and discharge it outside. If a residential area has rich radon gas in a sump pit, but is not rich in underground water, the pump could work more often and draw more water but the underground water may not be replenished enough to sustain the radon drawing process. To prevent it from happening, a water tank 27 is added. Said tank 27 has an inlet and an outlet. Said inlet of said water tank 27 is hooked to said discharge pipe 6 and said outlet of said water tank 27 is connected to the discharge pipe 28 leading to the outside. The discharged water by said sump pump, together with the drown radon gas by said venturi nozzle 5, is pumped into the tank 27 and then is discharged into the atmosphere through the venting pipe 28 after said tank is full. The sump pump stops when both conditions are met: Radon sensor senses no radon and the water level is below to a curtain predetermined level. The flow chart for the pump control is shown in FIG. 3. The float 24 is connected to a connecting rod 23 and said rod 23 controls a water valve 29. When said system is working and water level reaches to such a level that said float 29 and said rod 23 releases said valve 29. The water in said tank 27 will be released into said pump bit to replenish water and keep water to a certain level to sustain the radon drawing process. The valve 29 can be also controlled by a floating switch mounted on the well wall (not shown in the figure). The light-material-made retention cover 30 is mounted to the top of said radon inlet 8. Said float 7 is mounted to the middle of said radon inlet 8. The three piece moves together upward and downward with the water level in said pump pit along said inlet pipe 7. Said water tank 27 is supported by an adjustable base 25. Said base has two pieces: upper body 33 and lower body 34. Said upper body 33 has a larger pipe mounted on its bottom and said lower body 34 has a smaller cylinder mounted on its top end. Said cylinder is inserted into said pipe on said upper body 33 and is fixed with a bolt.

FIG. 4 is a schematic diagram of the radon inlet 8. The two O-ring seals 31 are placed between radon pipe 2 and radon inlet 8. The cover 30 is mounted on the top end of the radon inlet pipe 8.

While the invention has been described in conjunction with specific embodiments thereof, it is evident that many alterations, modifications, and variations will be apparent to those skilled in the art within the scope and the spirit of the foregoing description. Accordingly, this invention is not limited to the illustrated embodiments and is intended to embrace all such alterations, modifications, and variations in the appended claims.

1. A radon removing system suitable for a residential area in which it is rich underground water and no-so-rich in radon gas, which is added to an existing sump pump system in a sump pit in a dwelling basement, uses the sump pump as power source to draw the radon gas and uses the existing venting pipes in the sump pump system to discharge the radon gas into the atmosphere comprising:
A Venturi nozzle, inserted into the discharging pipe of the existing sump pump venting systems, which is used to draw radon gas when said sump pump draws the water into the discharging pipe;
A radon retention cover which is supported by 3 notches on said sump pit wall.

2. The radon removing apparatus of claim 1 further comprising of a radon inlet which is perforated on its upper body and its top end is closed;
A radon inlet pipe which is connected to said venture nozzle in one end and connected to said radon inlet in another end. Said radon inlet pipe is inserted on said radon inlet and said radon inlet and said radon inlet pipe are sealed with two O-ring seals. Said radon inlet can slide upwardly and downwardly along said radon inlet pipe;
A buoy made of light material and mounted to said radon inlet. Said buoy floats on the water surface together with said radon inlet;

3. A radon removing system suitable for a residential area in which radon gas is rich and underground water is not-so-rich, which is added to an existing sump pump system in a sump pit in a dwelling basement, uses the sump pump as power source to draw the radon gas and uses the existing venting pipes in the sump pump system to discharge the radon gas into the atmosphere and a water tank to store anD replenish the water comprising:
A Venturi nozzle inserted into the discharging pipe of said sump pump venting systems which is used to draw radon gas when said sump pump draws the water into the discharging pipe;
A radon inlet which is perforated on its upper body and its top end is closed;
A radon inlet pipe which is connected to said venture nozzle in one end and connected to said radon inlet in another end. Said radon inlet pipe is inserted into said radon inlet and said radon inlet and said radon inlet pipe are sealed with two O-ring seals. Said radon inlet can slide upwardly and downwardly along said radon inlet pipe;
A buoy made of light material and mounted to said radon inlet. Said buoy floats on the water surface together with said radon inlet;
A radon retention cover which is mounted to the top of radon inlet.

4. The radon removing apparatus of claim 3 further comprisingl of a water storage and replenish tank which includes a float, a coupling means, a release valve, and one inlet which is connected to the outlet of said water discharge pipe, and one outlet which is connected to said discharge pipe leading into the atmosphere.
